(19) United States
(12) Patent Application Publication
(10) Pub. No.: US 2003/0034882 A1
(43) Pub. Date: Feb. 20, 2003

(54) Real time vehicle alert system

(75) Inventors: Dwip N. Banerjee, Austin, TX (US); Rabindranath Dutta, Austin, TX (US)

Correspondence Address: Andrea Pair Bryant, 5202 Vista West Cove, Austin, TX, 78731, US

(73) Assignee: International Business Machines Corporation, Armonk, NY (US)

(21) Appl. No.: 09/920,407

(22) Filed: Aug. 2, 2001

(51) Int. Cl. B60Q 1/00

(52) U.S. Cl. 340/425.5

(57) ABSTRACT

A method, system and program product are provided for enabling a third party to instantly notify a remotely located vehicle owner by sending a message to an IP addressable onboard vehicle computer, which in conjunction with a vehicle alert server, retrieves owner supplied contact information, which may be an IP address and/or telephone number, and forwards the third party message to a device with the IP address or telephone number previously supplied by the owner.

### BACKGROUND OF THE INVENTION

1. Field of the Invention

The present invention relates to automated vehicle alert systems. More specifically, it relates to an Internet enabled, onboard vehicle computer for instantly notifying a remote owner upon receipt of a third party initiated contact.

2. Description of Related Art

Various types of vehicular alarm and alert systems are known in the prior art. Typically, those providing notification to a remote, i.e. not in the vehicle, owner rely on telephone communication to alert the owner to a condition detected in the vehicle. U.S. Pat. No. 4,989,146 to Imajo converts vehicle diagnostic data for transmission over telephone lines to a remote computer at a service firm. JP2162137 to Kazuhiro et al. relates to using a telephone in the vehicle to announce vehicle abnormalities. U.S. Pat. No. 4,821,309 to Namekawa discloses pre-storing the telephone number of an owner, or designee, in a motor vehicle telephone system, and, upon detecting a theft, automatically dialing the pre-stored number.

Automobile manufacturers now offer systems enabling wireless communication with their vehicles. VOLVO on CALL causes a vehicle telephone to automatically dial the Volvo system upon the occurrence of certain conditions. General Motors offers the ON STAR system which includes the capability of notifying a central service computer in certain conditions such as after the passage of a predetermined time interval after airbag inflation in which no call has originated from the vehicle.

U.S. Pat. No. 5,732,074 to Spaur et al. Discloses a mobile portable wireless communication system utilizing the Internet for enabling communication between a vehicle having plural devices and at least a remote computer. The vehicle contains a controller having a number of hardware and software elements including a processor.

Prior art devices and systems do much to impart technological advantages to vehicles currently available. These systems and devices, even with Internet capability, provide automated contact to a central service system computer or to a remote owner in response to some condition detected in the vehicle. There are occasions, however, when it is necessary to contact the remote owner of a vehicle. Third parties sometimes need to quickly contact the owner of a vehicle to advise of a current or upcoming situation of importance to the owner, such as a flood warning, impending street closing or the like. Thus it would be desirable to have a system which would allow third parties, unrelated to the vehicle manufacturer or owner, to contact the owner in real time.

### SUMMARY OF THE INVENTION

The present invention supplies that above noted shortcoming of the prior art. The present invention provides a method and system for enabling third party initiated, vehicle to owner communication, in effect using an appropriately equipped vehicle to relay information to its owner. The present invention includes a server connectable via the Internet to a vehicle, its owner and certain prescribed third parties such as law enforcement or other governmental agencies. A vehicle is provided with an onboard computer which is Internet addressable. Messages sent over the Internet from external third parties, such as police needing to clear a street, are relayed by the vehicle's onboard computer to the owner. An owner may they take appropriate action by coming to move the vehicle. An owner may receive a message relayed by his/her vehicle on any Internet enable device such as a cell phone, personal digital assistant or another computer.

### BRIEF DESCRIPTION OF THE DRAWING

The above and other features and advantages of the present invention will become clear from the following detailed description of a preferred embodiment taken in conjunction with the various figures of the drawing in which like reference numerals and symbols are used throughout to indicate the same elements, and in which:

FIG. 1 is a block diagram of the main components of a system in which the present invention may be practiced;

FIG. 2 shows, in block diagram form, features of onboard vehicle computer 10;

FIG. 3 depicts the primary components of vehicle alert server 14 of FIG. 1; and

FIG. 4 is a flow chart of the logic followed during operation of the present invention.

### DETAILED DESCRIPTION OF A PREFERRED EMBODIMENT

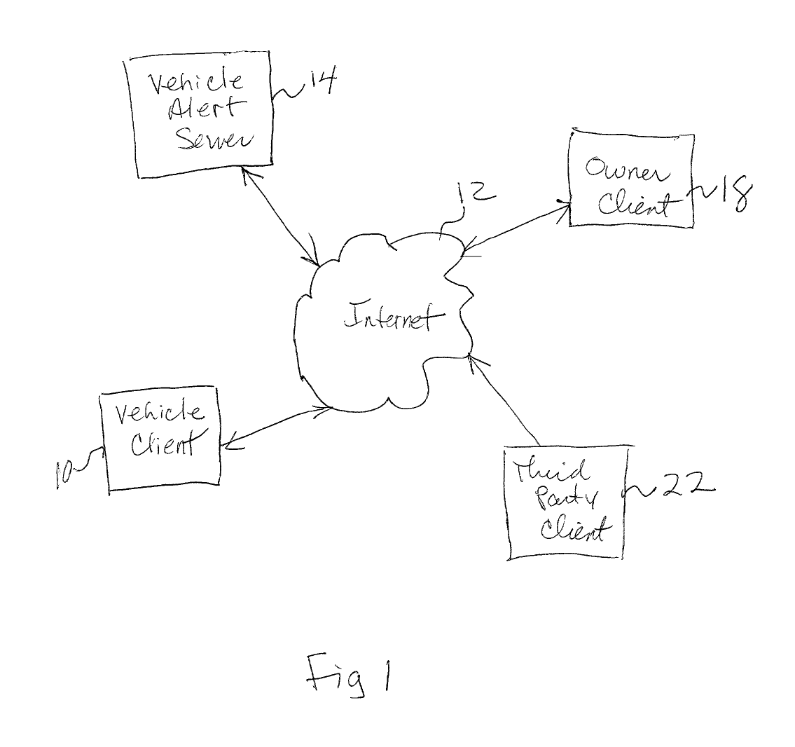

The principle elements of a system embodying the present invention are shown in FIG. 1. The present invention provides instant communication to a vehicle owner via the Internet. An onboard vehicle client computer 10 is addressable via the Internet 12. Vehicle alert server 14 may be remotely located or be integral with onboard vehicle computer 10. Server 14, which will be described in greater detail below, controls two way communication between onboard vehicle client computer 10 and owner client 18.

Third party 22 may communicate with onboard vehicle computer 10 under control of server 14. Third party 22 communication with onboard vehicle computer 10 is one way, for immediate relay to owner client 18.

Onboard vehicle client computer 10 may be a state of the art vehicle computer which among its tasks, monitors various vehicle subsystems for status, diagnostic and maintenance purposes. Such computers are well known in the art. In accordance with the present invention, onboard vehicle computer 10 is also provided with a standard, simple IP address. Those having skill in the art will appreciate that it is expected that many devices such as onboard vehicle computers will be provided addresses in accordance with well known standards IPv4, IPv6. For example, the license number of the vehicle may be used as an identifier when addressing an onboard vehicle computer such as vehicle client computer 10 via the Internet.

Using this address, a vehicle owner is able to communicate with his/her vehicle and vice versa. Those having skill in the art will also appreciate the programmability aspect of onboard vehicle client computer 10 and/or an onboard telephone system which permits an owner to provide plural numbers at which he/she may be reached by onboard vehicle client computer 10 in case of situations arising in and around the car. In accord with the present invention an owner provides the IP address of owner client 18. Owner client 18 may be a cell phone, personal digital assistant or other device which is IP addressable. In a modification, a vehicle owner may provide a telephone number, or more than one, which may be automatically dialed by vehicle computer 10. The owner may provide several IP addresses, and/or telephone numbers, in priority order as well as change the IP addresses/telephone numbers as he/she desires.

A third party client 22 is provided to send an alert, which may be an instant message, to vehicles equipped with an onboard vehicle client computer 10 when owner contact is immediately required. Such situations may include an emergency requiring a street to be cleared of parked cars. Third party client 22 may be a handheld device carried by law enforcement officers. Advantageously, third party client 22 may be a wireless application protocol (WAP) device such as a telephone to initiate a message to a vehicle owner.

Alternatively, third party client 22 may be a remote computer which is capable of sending messages to vehicles whose location is known through GPS or similar locating system. This capability of centrally originating messages to plural vehicles, whose location only is known, is particularly advantageous, for example, in cases where a parade route needs to be cleared for VIP transit. Those having skill in the art will appreciate that these situations are stated merely for illustrative purposes and that the present invention may be utilized in many other situations.

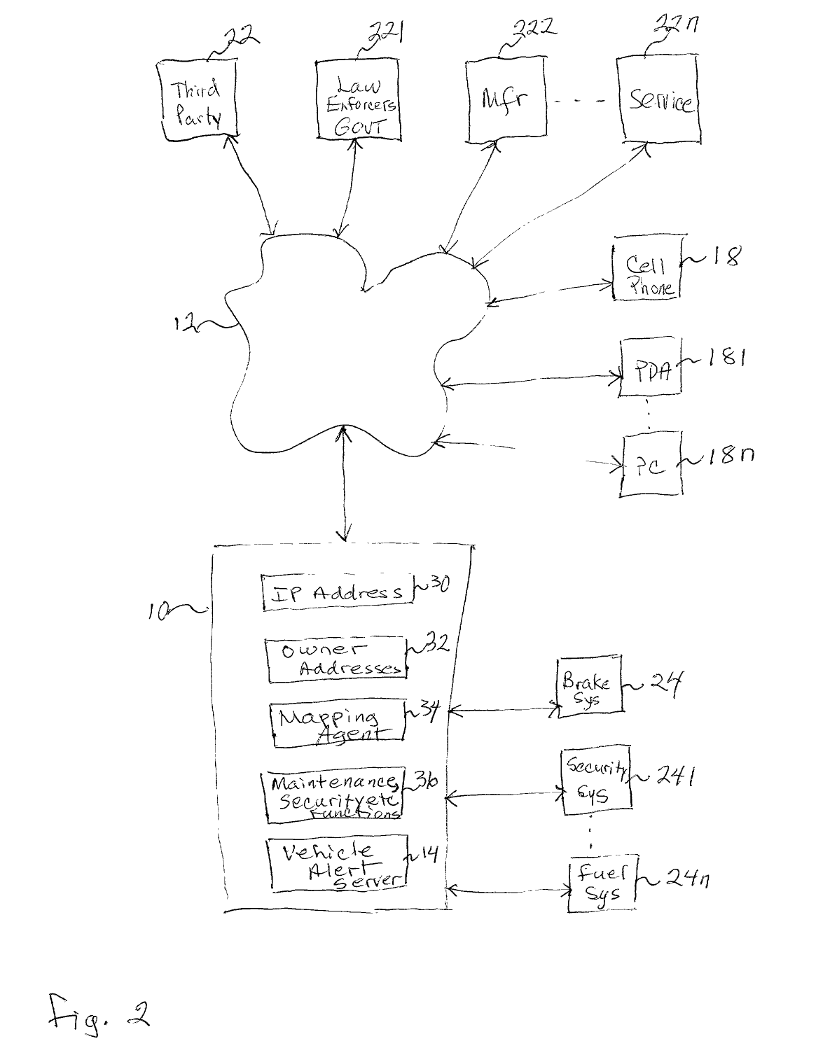

Refer now to FIG. 2 for an understanding of features of onboard vehicle computer 10. As is well known in the art, onboard vehicle computer 10 is provided with the capability to monitor vehicle performance and operation parameters such as fuel, ignition, security and braking systems. It is also understood that current vehicle computers may be enabled for communication with a cental computer maintained by the vehicle manufacturer and/or authorized service center. It is also known today to have the capability of communication with the vehicle owner/user. What is provided by the present invention to conventional onboard vehicle computers is the capability of receiving over the Internet messages initiated by third parties, which messages are then forwarded to the vehicle owner at an IP addressable device remote from the location of the vehicle. Thus, the present invention provides a relay functionality whereby third party initiated messages are forwarded to a current address, IP or telephone, of a vehicle owner.

Refer now to FIG. 2 wherein three vehicle owner clients are illustrated. Owner client 18 represents an owner cell phone. An owner of a vehicle equipped with the present invention has an option to provide multiple contact locations. An owner client 181 may be a personal digital assistant on other IP addressable handheld device. Similarly, owner client 18n may be the personal computer of the owner.

In addition to receiving messages initiated by third party client 22 (FIG. 1), onboard vehicle computer 10 may also receive via the Internet messages or other communication originated elsewhere. That is, although only one third party client is illustrated in FIG. 1, any external, remotely located device connectable to the Internet may communicate with onboard vehicle computer 10, given its IP address. Thus, in FIG. 2 there are additional third party clients shown. Third party client 221 represents law enforcement and other governmental entities. Third party client 222 represents the vehicle manufacturer and third party client 22n may be a vehicle service entity. Those skilled in the art will appreciate that these and other third parties including, but not limited to, financial institutions and insurance agencies could advantageously employ the system of the present invention. Vehicle onboard computer 10 may be advantageously programmed to additionally send information to such third party clients in the case, for example, where the security subsystem of the vehicle has been breached.

In FIG. 2 various electrical and mechanical subsystems 24, 241, 24n are shown connected to onboard vehicle computer 10 in a conventional manner for conventional purposes. Vehicle subsystem 24 represents the vehicle brake subsystem. Vehicle security subsystem is indicated at 241 and the vehicle fuel subsystem is shown at 24n. Those having skill in the art will appreciate that any number of subsystems may exist in modern vehicles and the three shown in the figure are exemplary in nature.

Onboard vehicle computer 10 is network addressable in accord with the present invention. An IP address 30 is therefore provided. Maintained in memory 32 associated with onboard computer 10 are data needed to contact the vehicle owner. This contact information is provided by the owner and may be updated as the need arises. Onboard vehicle computer 10 includes mapping/relay agent software 34 which forwards messages sent to the vehicle to a current owner address (IP or telephone). That is, agent 34 provides a mapping from the IP address of the vehicle to a current, owner supplied address. Functionality 36 necessary to interpret and use information supplied to onboard vehicle computer 10 by the various vehicle subsystems 24-24n is also included.

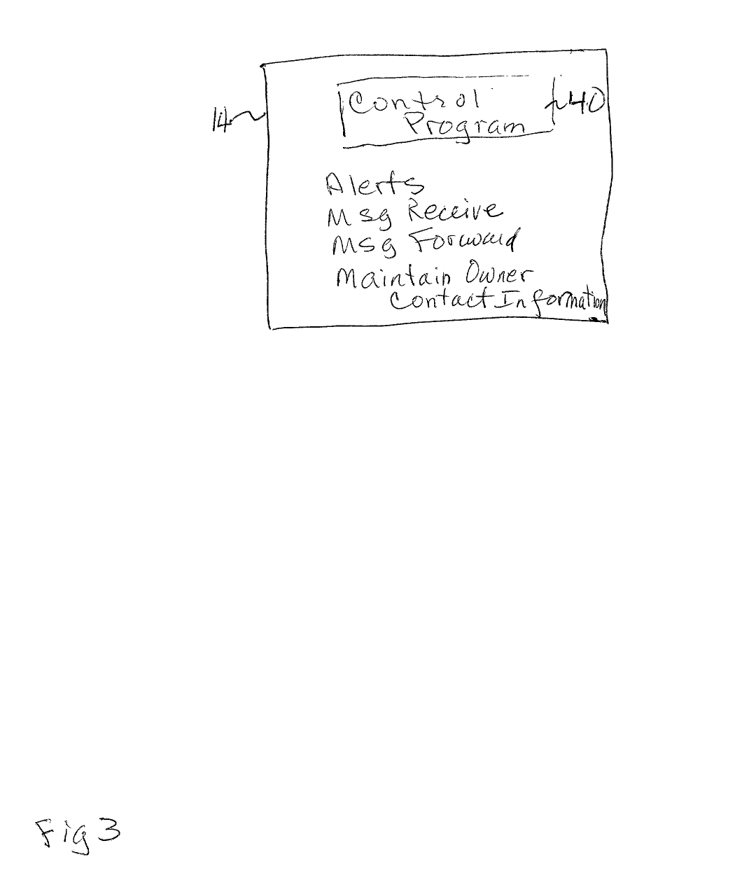

Refer now to FIG. 3 for a more detailed description of vehicle alert server 14 which includes functional components for carrying out the present invention. While vehicle alert server 14 is shown in FIG. 1 as a separate device, those having skill in the art will understand that as shown in FIG. 2 vehicle alert server 14 may be integral with vehicle onboard computer 10. The function of vehicle alert server 14 remains the same whether it is part of vehicle onboard computer 10 or it is included in a computer located remote from the vehicle.

Vehicle alert server 14 comprises a computer program 40 for carrying out the principle steps in the method of the invention. Program 40 includes a mechanism for registering owner supplied forwarding IP addresses. Program 40 accepts and appropriately updates owner notification information stored in memory at onboard vehicle computer 10. Program 40 receives messages initiated by a third party and forwards the message to an owner at a previously registered IP address, preferably using WAP. Program 40 is set up to appropriately interface with I/O and communication devices necessary to receive, interpret, and prepare for forwarding messages initiated by third parties to an owner client. It is able to receive, interpret and otherwise process owner supplied information.

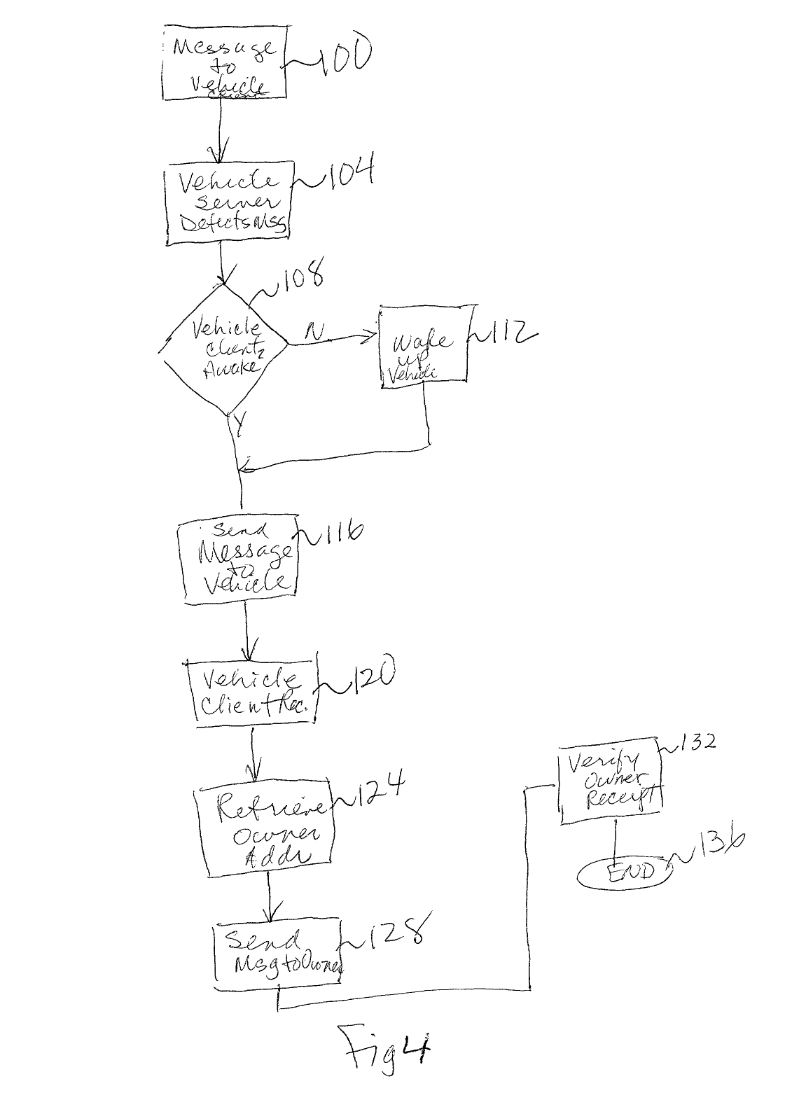

FIG. 4 depicts the logic followed by program 40 during operation of the present invention. At step 100 a third party such as a law enforcement official wishes to notify the owner of a vehicle, equipped in accordance with the invention, of the need to have the vehicle moved. The law enforcement official sends a message via the Internet addressed to vehicle client 10 (FIG. 1). Upon receiving the third party message at step 104, program 40 ascertains at query 108 whether vehicle client 10 is awake and ready to receive a message. If not, then program 40 wakes up client 10 as indicated at step 108. A Push mechanism, well known in the art e.g. as used in the WAP protocol, may be used to deliver a message which is in effect relayed from a third party to the vehicle owner.

Once vehicle client 10 is enabled for message receipt, program 40 completes the sending of the third party message to vehicle client 10. At step 120 vehicle client 10 message receipt occurs. At step 124 vehicle client 10 then retrieves its previously stored, owner supplied, owner client 18 IP address and uses that IP address to relay the third party message to owner client 18 as represented at step 128. For example, if the license number of the vehicle serves as the identifier for the IP address of the vehicle, owner client IP address retrieval involves mapping the license number to IPv6 addresses previously stored as a forwarding address(es) by the vehicle owner.

Program 40 then takes steps to verify message receipt at owner client 18. Should there be no answer, the vehicle alert system of the present invention would advantageously iterate through retrieval step 124, send step 128 and verification step 132 until a stored IP address is found at which there is an answer before ending at step 136.

As noted above, owner client 18 may in fact be an Internet enabled cell phone. The owner of the vehicle containing vehicle client 10 may then go to his/her vehicle and take whatever action is appropriate, e.g., move the car to a different location.

What has been shown and described is a method and system for allowing prescribed third parties to instantly alert a remotely located vehicle owner of situations requiring owner intervention. A third party is able to send a message to an IP addressable onboard vehicle client computer, which under control of a novel vehicle alert server relays the third party message to an IP addressable owner client.

While the invention has been described having reference to a particular, preferred embodiment those having skill in the art will appreciate that modifications in form and detail may be made without departing from the spirit and scope of the appended claims.

What is claimed is:

1. A computer implemented method of instantly alerting a remotely located vehicle owner of a situation requiring owner intervention comprising the steps of:
detecting receipt of an external message to an IP address of an onboard vehicle client;
in response to said detecting, causing said onboard vehicle client to locate an IP address supplied by said owner; and
forwarding said external message to said owner IP address.

2. The method of claim 1 wherein said causing step includes:
retrieving from a storage location in said onboard vehicle client a most recently supplied owner IP address.

3. The method of claim 2 wherein said forwarding step includes:
sending an instant message to a device having said owner IP address.

4. An information handling system for instantly alerting a remotely located vehicle owner of a situation requiring owner intervention comprising:
means for detecting receipt of an external message to an IP address of an onboard vehicle client;
means, active in response to said means for detecting, for causing said onboard vehicle client to locate an IP address supplied by said owner; and
means for forwarding said external message to said owner IP address.

5. The system of claim 4 wherein said means for causing includes:
means for retrieving from a storage location in said onboard vehicle client a most recently supplied owner address.

6. The system of claim 5 wherein said means for forwarding includes:
means for determining whether said owner address is an IP address or a telephone number;
means, responsive to said owner address being an IP address, for sending an instant message to a device having said owner IP address; and
means, responsive to said owner address being a telephone number, for calling said number.

7. The system of claim 6 wherein said device is a cell phone.

8. The system of claim 6 wherein said device is a personal digital assistant.

9. A computer program product for instantly alerting a remotely located vehicle owner of a situation requiring owner intervention comprising:
means for detecting receipt of an external message to an IP address of an onboard vehicle client;
means, active in response to said means for detecting, for causing said onboard vehicle client to locate an address supplied by said owner; and
means for forwarding said external message to said owner address.

10. The computer program product of claim 9 wherein said means for causing includes:
means for retrieving from a storage location in said onboard vehicle client a most recently supplied owner address.

11. The computer program product of claim 10 wherein said means for forwarding includes:
means for determining whether said owner address is an IP address or a telephone number;
means, responsive to said owner address being an IP address, for sending an instant message to a device having said owner IP address; and
means, responsive to said owner address being a telephone number, for calling said telephone number.

12. An information handling system including a plurality of Internet enabled clients and a vehicle alert server, said server comprising:
means for detecting transmission of a message from a first client addressed to a second client;
means for determining from said second client an address for a third client; and
means for sending said message to said third client.

13. The information handling system of claim 12 additionally including:
means for verifying receipt of said message by said third client.

14. The information handling system of claim 13 additionally comprising:
means responsive to said means for verifying for iteratively activating said means for determining, means for sending and means for verifying until said means for verifying indicate affirmative receipt.

15. The system of claim 12 wherein said second client is an onboard vehicle computer in a vehicle.

16. The system of claim 15 wherein said first client is a third party external to said vehicle.

17. The system of claim 16 wherein said third client is remote from said vehicle and accessible to an owner of said vehicle.

18. The system of claim 17 wherein said means for detecting includes:
means for interpreting whether said message is addressed to an IP address containing a license plate number matching that of said vehicle.

19. The system of claim 18 wherein said means for determining comprises:
means for mapping said address into a list of previously supplied owner addresses for finding a forwarding address for use by said means for sending.

20. The system of claim 19 wherein said means for sending comprises:
means for sending said message over the Internet if said forwarding address is an IP address; and
means for sending said message using a wireless application protocol if said forwarding address is a telephone number.

21. The system of claim 20 wherein said means for sending additionally comprises a Push mechanism.

22. A method implemented in an information handling system including a plurality of Internet enabled clients and a vehicle alert server, comprising:
detecting transmission of a message from a first client addressed to a second client;
determining from said second client an address for a third client; and
sending said message to said third client.

23. The method of claim 22 additionally including:
verifying receipt of said message by said third client.

24. The method of claim 23 additionally comprising:
means for iteratively repeating said determining, sending and verifying steps until an affirmative response is obtained.
